(19) United States
(12) Patent Application Publication
(10) Pub. No.: US 2009/0204917 A1
(43) Pub. Date: Aug. 13, 2009

(54) DISTANCE MEASURING DEVICE

(76) Inventor: Uwe Skultety-Betz, Leinfelden-Echterdingen (DE)

Correspondence Address: MERCHANT & GOULD PC, P.O. BOX 2903, MINNEAPOLIS, MN, 55402-0903, US

(21) Appl. No.: 12/306,419

(22) PCT Filed: Jul. 26, 2007
(86) PCT No.: PCT/EP2007/057713

§ 371 Date: Dec. 23, 2008

(30) Foreign Application Priority Data
Sep. 1, 2006 (DE) 102006041077.7

(51) Int. Cl. G06F 3/048

(52) U.S. Cl. 715/764; 715/863; 702/158

(57) ABSTRACT

The invention relates to a distance measuring device comprising a control unit. According to the invention, the control unit has a drawing mode that is used to create drawings.

### TECHNICAL FIELD

The invention is based on a distance measuring device according to the generic term of claim 1.

### BACKGROUND

A distance measuring device for measuring distances is known. It has a control unit, which is provided to implement at least one operating mode of the distance measuring device.

### SUMMARY

The invention is based on a distance measuring device with a control unit.

It is suggested that the control unit has a drawing mode, which is provided to create drawings. To ‘create’ the drawing can thereby especially mean the making of the drawing or the editing of a present drawing. Thereby a high comfort and a high flexibility of the application of the distance measuring device can be achieved. The drawing is preferably created by drawing data, which are entered by an end-operator, as for example drawing dictations or distance information of a distance that has to be measured has been measured. The drawing data can furthermore be distance parameters, which are determined by a measuring unit of the distance measuring device. The control unit preferably provides a memory unit, in which at least one program for implementing the drawing mode is incorporated. The creation of the drawing can take place by operating a keyboard of the distance measuring device, for example by a navigation in a drawing program.

A very easy operation in the creation on the drawing can be achieved, when the distance measuring device provides a touch-sensitive input unit, which can together with the control unit create the drawing. ‘Touch-sensitive input unit’ means here especially an input unit, which is provided for an almost pressure-free input. Thereby the input unit can be provided with a touch-detector, which can detect a touch for example by a capacitive sensing, especially a pressure-free touch of a surface of the input unit. Alternatively or additionally the touch-sensitivity of the input unit can be achieved by a resistance-controlled detection. Based on the principle of a light barrier a detection of a touch, especially a pressure-free touch, for example by infrared radiation source, is also possible. In a further embodiment the input unit can also be provided for detecting the touch by detection that is controlled by sound waves, which can be achieved for example by using piezo-electric elements.

The input unit can for example be arranged as a touch pad or as track point. The input unit can furthermore provide a touch-sensitive area, which is produced by the display unit. Preferably the input unit is produced by a touch screen. The distance measuring device is advantageously supplied with a track point, which can be used together with the input unit for operating the distance measuring device.

It is furthermore suggested, that the control unit is provided to create the drawing by a sketching by an operator, whereby a very easy and intuitive creation of the drawing can be achieved.

A precise creation of the drawing can be achieved in this context when the control unit is provided to at least semi-automatically process a distance that is sketched by an operator. A distance that has been sketched by an operator can for example be straightened out and/or aligned in a desired direction by the control unit.

It is conceivable in another embodiment that the control unit is provided to create the drawing with the aid of reference points, which are entered by the operator. It is possible in a further embodiment to create the drawing by the operator with the aid of default drawing symbols.

It is furthermore suggested that the distance measuring device provides a memory device for saving the drawing. Thereby the flexibility of the application can be further increased by for example advantageously archiving the measurements of several spaces. Furthermore the operator can create drawing models, save them in the memory device and activate them for editing at a later point of time.

It is suggested in an advantageous improvement of the invention that the control unit is provided to create the drawing with the aid of a measuring result at least semi-automatically. Thereby a drawing can be created very precisely and easily. In particular a drawing of a measured space can be obtained that is true to scale.

An extremely high operating comfort can be further achieved when the control unit is provided to adjust the drawing to a measuring result. The operator can first create a drawing, for example a rough sketch of a space that has to be measured with the aid of a touch-sensitive input unit, and carry out measurements, whereby the control unit automatically adjusts the drawing true to scale to the measuring result after the measurements.

It is suggested in a further embodiment of the invention that the distance measuring device comprises a data interface and that the control unit provides a program for implementing the drawing mode, which is provided to create the drawing with the aid of data that is read over the data interface. Thereby the flexibility of the application of the distance measuring device can be further increased.

It is furthermore suggested that the control unit has an operating mode, in which a display field for displaying distance information is assignable by the input of an operator to a distance that has been determined by the drawing. A ‘display field’ means in this context especially an area of a display unit of the distance measuring device, whose dimension is coordinated for displaying a parameter, especially a number and a unit if necessary.

An extremely high flexibility in creating the drawing can be achieved when the operating mode is provided to place the display field in a desired position relative to the drawing by an input of the operator. The distance that has been ‘determined’ by the drawing can be a distance that is shown in the drawing. Furthermore this distance can be a distance that is not shown in the drawing, which is determined by two points in the drawing, as for example a diagonal.

A very simple operation of the distance measuring device can be achieved when the control unit is provided to assign a control function for controlling a measurement of the distance to a shown distance symbol that is assigned to a distance. In particular an elaborate navigation in a shown menu can be avoided. The measuring process can for example be activated, terminated, repeated and so on. This symbol can for example be a shown distance or a display field that is assigned to a distance.

It is suggested in a further embodiment of the invention that the distance measuring device comprises a data interface for creating a data connection with a pressure unit and that the control unit provides a pressure mode, in which the control unit transfers pressure data to the pressure unit with the aid of the drawing, whereby a document that concerns a space can be created extremely fast and flexibly. The data interface can be arranged extremely advantageous as an adapter unit, at which the pressure unit, for example a thermal printer, can be attached.

It is further suggested that the distance measuring device comprises a data interface and that the control unit provides an operating mode, which is provided to download a program for implementing the drawing mode over the data interface from an external data unit. The drawing mode can be thereby advantageously updated and/or optionally upgraded with additional functions. A program for implementing the drawing mode can further be downloaded optionally upon a request of the end-user after creating the distance measuring device.

### BRIEF DESCRIPTION OF THE DRAWINGS

Further advantages arise from the following drawing description. The drawing shows embodiments of the invention. The drawing, the description and the claims contain several characteristics in combination. The expert expediently considers the characteristics also individually and combines them to further useful combinations.

FIG. 1 is a distance measuring device with a touch screen and a track point;

FIG. 2 is a schematic illustration of the touch screen from FIG. 1, on which a drawing is sketched with the aid of the track point;

FIG. 3 is a schematic illustration of a drawing mode, in which a rough sketch is processed;

FIG. 4 is a drawing mode, in which a display field is moved with the aid of the track point;

FIG. 5 is a drawing mode, in which a drawing is adjusted to measuring results;

FIG. 6 is a drawing mode, in which a measuring process is started by operating a symbol;

FIG. 7 is a drawing mode, in which a drawing is created with the aid of external data;

FIG. 8 is an editing mode, in which a chart with distance information is created;

FIG. 9 is the connecting of a pressure unit to the distance measuring device; and

FIG. 10 is an alternative embodiment of the distance measuring device with a touch screen and an operating element.

### DETAILED DESCRIPTION

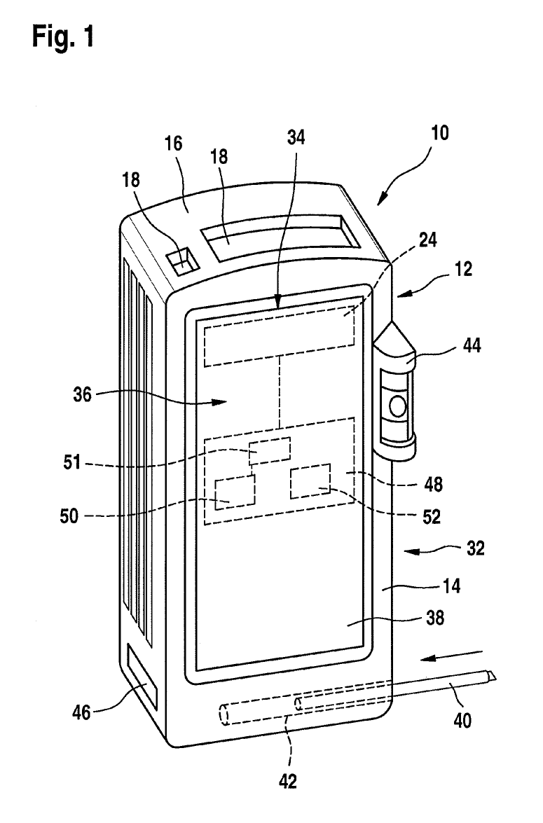

FIG. 1 shows a distance measuring device 10 from a perspective view. The distance measuring device 10 provides a body 12 that builds an operating side 14 and a signal side 16 that adjoins to the operating side 14. The signal side 16 has optical components 18, by which an optical measuring signal 20, especially a laser signal, is send or received (see FIG. 5). With the aid of the measuring signal 20 a distance of the distance measuring device 10 can be determined to an object 22 that has to be measured. For creating, receiving and processing the measuring signal 20 the distance measuring device 10 is supplied with a measuring unit 24, which provides a sender unit 26, a receiver unit 28 and an analyzer unit 30 for analyzing the received measuring signal 20 (see FIG. 5).

The operating side 14 provides an operating interface 32, which is proved for the communication with an operator. The operating interface 32 comprises a display unit 34 that is arranged as a screen and that is provided for displaying information. The display unit 34 is arranged as a touch screen and creates a touch-sensitive input unit 36. Therefore the display unit 34 provides a transparent screen layer, whose surface builds a contact area 38 of the input unit 36, which is provided for the input of information by touching it. The input unit 36 is provided for detecting a touch with the aid of a resistance-controlled detection in this example. Therefore the input unit 36 provides a further transparent screen layer (not shown in the figure), which is arranged distanced and below this upper screen layer that creates the contact area. The screen layers are conductive and arranged as ITO-layers (or indium tin oxide layers). By touching the upper screen layer the screen layers contact each other electrically. Due to the resistance of this contact an electrical voltage arises at the point of contact, which can be detected with not shown sensors. The detected voltage change can be used for determining the coordinates of the point of contact.

The contact area 38 creates a contact surface that is provided for an input and that stretches advantageously over a significant part of the operating side 14, in particular over ca. 70% of the operating side 14.

For operating the input unit 36 the distance measuring device 10 is provided with a track point 40. A receiving area 42 for receiving the track point 40 is omitted in the body 12. Thereby a detaching of the track point 40 from the body 12 during a transportation of the distance measuring device 10 can be avoided. It is conceivable in one embodiment that a fastener is used to fasten the track point 40 to the surface of the body 12. Furthermore a level 44 is fixed to the body 12. Besides the distance measuring device 10 provides a data interface 46 that is arranged as a blue-tooth interface and that is provided for creating a data connection with an external data unit (see FIG. 7).

For implementing the operating modes of the distance measuring device 10 it is provided with a control unit 48. The control unit 48 comprises a first memory unit 50, in which programs for implementing the operating modes of the distance measuring device 10 are saved. The controlling of the operating modes takes place with the aid of a processing unit 51 that is arranged as a processor or as a microcontroller together with a memory unit 50. Furthermore a second memory unit 52 is arranged in the control unit 48, whose function is described further down.

The control unit 48 is especially supplied with operating modes, which are each provided as drawing modes for creating a drawing. These drawing modes are explained with the aid of the following figures.

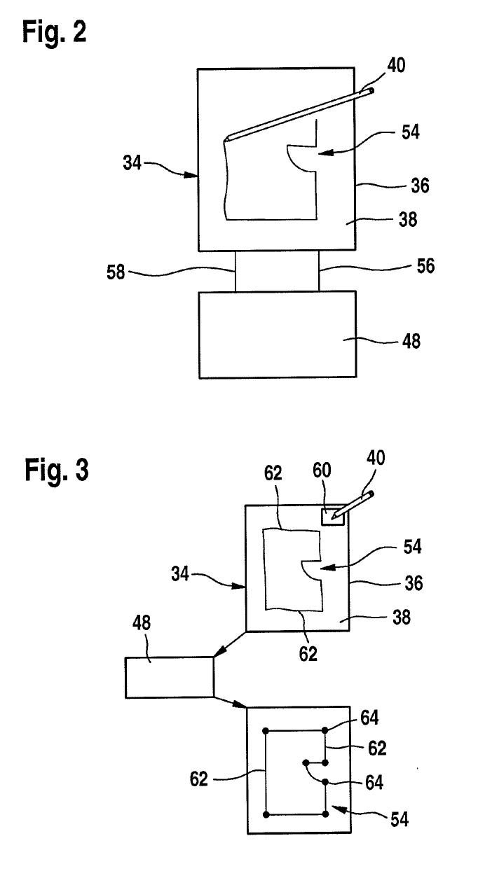

FIG. 2 shows the input unit 36 and the control unit 48 in a schematic illustration. It is assumed that an operator undertakes the measurement of a space with the aid of the distance measuring device 10. Prior to the measurement the operator can create a drawing 54 with the aid of the input unit 36 in the form of a rough sketch of the space that has to be measured. Therefore the operator activates a drawing mode of the control unit 48, in which he can move the top of the track point 40 on the contact are 38 of the input unit 36 in order to sketch. In doing so the control unit 48 receives position information 56 of the successive positions of the track point 40 on the contact area 38 together with the (not shown in the figures) sensors of the input unit 36. With these position information 56 the control unit 48 creates the drawing 54, which is displayed by the display unit 34. Thereby control signals 58 for controlling the display unit 34 by the control unit 48 are determined with the aid of this position information 56.

The created rough sketch can further be processes in the drawing mode by the control unit 48. This processing function of the control unit 48 is explained by FIG. 3. The processing is activated by marking and/or operating an operating field 60 that is displayed by the display unit 34 with the aid of the track point 40 or a finger. An operating of a displayed field is schematically shown with the aid of a radiant field in this figure and in the following figures. The control unit 48 is supplied with a detection function, with which individual distances 62, which build the drawing 54, can be detected. These distances 62 can furthermore be determined by an input of the operator that marks the vertices 64 of the drawing 54 with the track point 40. When the individual distances 62 are determined the distances are straightening out and/or aligned. Optionally the operator can influence the distance processing if he accepts or declines suggested solutions and/or if he determines the alignment and/or the length of a distance 62 that has to be measured.

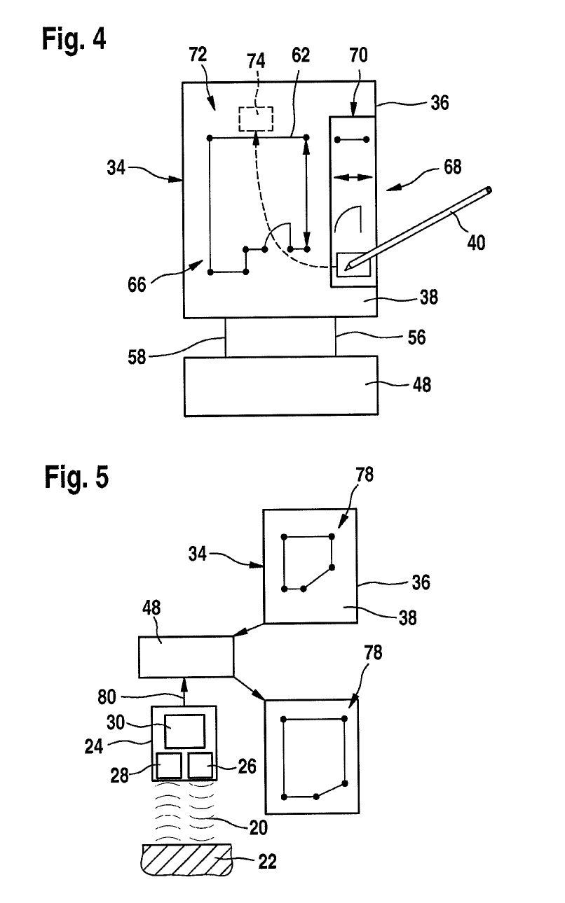

Another drawing mode of the control unit 48 is schematically shown in FIG. 4. The operator can create a drawing 66 with the aid of default symbols 68 in this mode. These are displayed in a toolbar 70, which is displayed on the side of a drawing field 72. To create the drawing 66 a symbol 68 can be marked with the track point 40 in the toolbar 70 and moved to a desired position into the drawing field 72.

A distance 62 that has been determined by the drawing can furthermore be assigned to a display field 74 for displaying distance information. Therefore the operator can mark a symbol 68 that represents the display field 74 and place it by a movement that is shown dotted in the figure to a desired position within the drawing field 72. The display field 74 in the drawing field 72 is an area of the display unit 34, which is provided in this example for displaying the length of the assigned distance 62 after its measuring. Alternatively or additionally a default sing for an assignment of the distance 62 can be displayed.

FIG. 5 explains another drawing mode of the control unit 48. It is assumed that an operator created a drawing 78 of a space that has to be measured, for example with the aid of an above described drawing mode. Subsequently the operator undertakes a measurement of the space with the aid of a measuring mode of the measuring unit 24. The control unit 48 is provided to adjust the drawing that has been created prior to the measurement to the measuring results 80 with the aid of the measuring results 80 that have been detected by the measuring unit 24, whereby an image of the space that has to be measured is created by the control unit 48 that is true to scale.

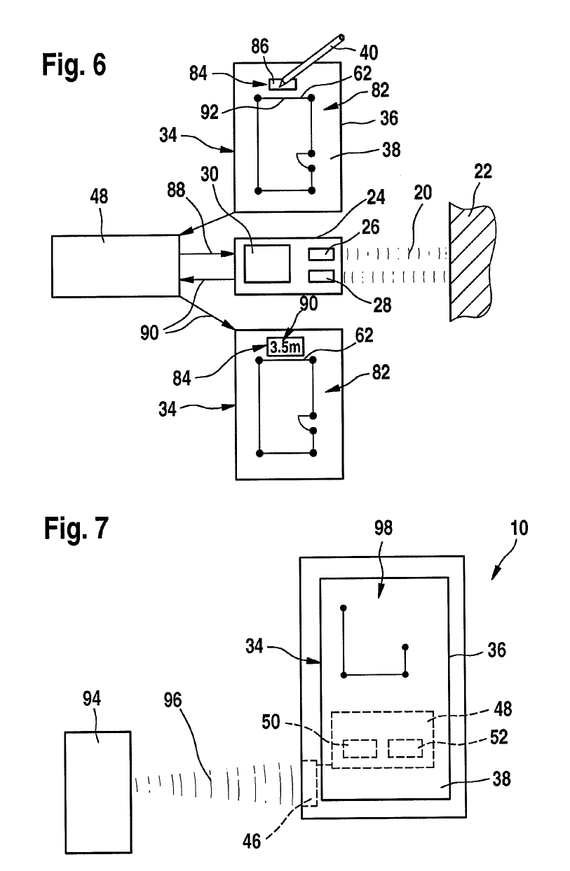

The control unit 48 is supplied with a further operating mode, which is explained by FIG. 6. It is assumed that the operator has created a drawing 82 of the space that has to be measured with the aid of the operating mode shown in FIG. 4, whereby a display field 84 for displaying a measuring result has been assigned to a specific distance 62 of the drawing 82. Furthermore it is assumed that the operator can mark and operate the symbol 86 that represents the display field 84 by a track point 40. That activated a control function of the control unit 48, which transfers a control signal 88 to the measuring unit 24 to activate a measuring process of the measuring unit 24, which detects a measuring result 90 with this measuring signal 20. After measuring the measuring result 90 is displayed by the control unit 48 in connection with the display unit 34 in a unit of length in the corresponding display field 84. In one embodiment of the operating mode the operator can directly mark and operate a symbol 92 that is arranged as a line and that shows the distance 62, whereby the measuring process of the selected distance 62 is activated. Besides it is conceivable that the operator is requested to activate the measuring process by for example a blinking of the symbol 86 and/or the symbol 92.

FIG. 7 shows a further drawing mode of the control unit 48. In this drawing mode a data connection is created with an external data unit 94, as for example a PDA (personal digital assistant) or a notebook. With the aid of data 96, which is read over the data interface 46, a drawing 98 is displayed according to the data by the control unit 48 together with the display unit 34. Alternatively or additionally to the display the imported data can be saved in the memory unit 52, where they are available for later processing. A drawing or drawing model that has been created by an external unit can be imported for example over the data interface 46. Besides the memory unit 52 can save drawings, which have been created by the operator with the input unit 36. It is conceivable in a further embodiment of the distance measuring device 10 that the data interface 46 is arranged as scan unit, with which a drawing, as for example a rough sketch, can be scanned.

In a further operating mode of the control unit 48 a program for implementing the operating modes, in particular the drawing modes of the control unit 48, can be also downloaded over the data interface 46. Thereby a data connection between the data interface 46 and the memory unit 50 is created. In doing so, the operator can update present programs and/or upgrade the control unit 48 with new operating modes, especially drawing modes.

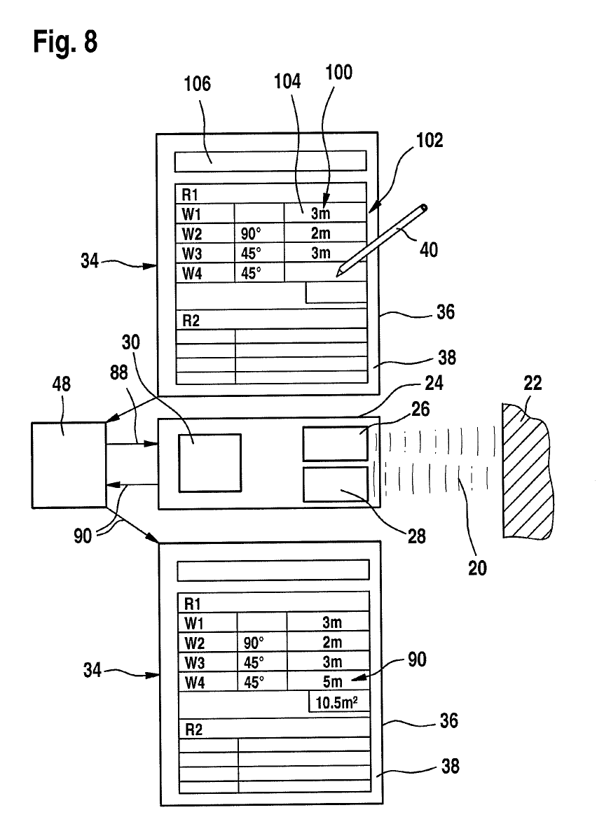

FIG. 8 shows a further operating mode of the control unit 48, in which distance information 100 can be processed with the aid of the input unit 36. In particular a chart 102 can be created in this operating mode. Distance information 100 about the space that has to be measured or has been measured can be registered and evaluated in this chart 102. Sub-charts R1, R2 and so on can be created, which are each assigned to a space. Thereby distance information 100, basically the name of the distance, which for example corresponds with a wall W1, W2, the detected length of the distance, an angle that is created by two bordering distances and so on, can be registered in display fields 104 of the sub-charts R1, R2. The operation takes place by a track point 40 and over a toolbar 106, which is displayed above the chart 102.

Furthermore a control function for controlling a measuring process of the measuring unit 24 is assigned to the display field 104 of the chart 102 in the operating mode. By marking and operating a display field 104, which corresponds with a distance that has to be measured, a measuring of the distance by the measuring unit 24 can be activated. This takes place analogously to the process, which is explained in figurer 6, together with a control unit 48. After measuring the distance the length of the distance is shown in the display field 104 with the aid of the measuring result 90. The chart 102 furthermore provides a calculating function, which automatically detects a surface or a volume of the corresponding space by distance lengths and angle values if necessary.

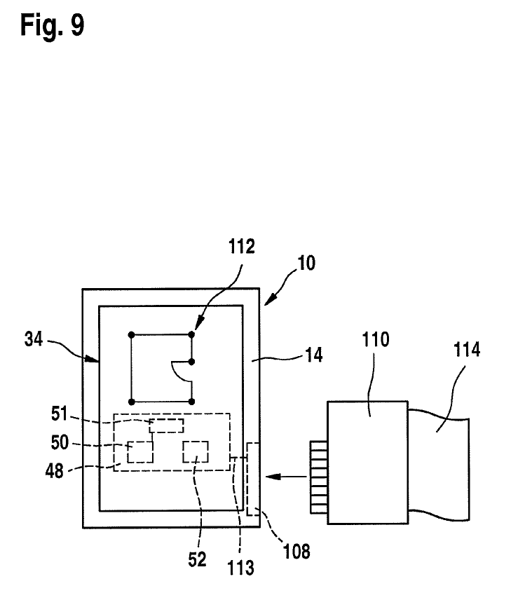

FIG. 9 shows the measuring distance device 10 in a further embodiment. Thereby the distance measuring device 10 provides a data interface 108, which is provided for creating a data connection with an external data unit 110. This data unit 110, which is arranged as a thermal printer, can be attached to the body 12 over this data interface 108, which is arranged as adapter unit with a fastener interface. Therefore the base body of the printer unit 110 is attached to the body 12. A data connection between the control unit 48 and a control unit of the printer unit 110 is created in a print mode of the control unit 48, whereby print data 113 is transferred by the control unit 48 to the print unit 110. With the aid of the print unit 113 a drawing 112 that has been created by an operator and that is saved in the memory unit 52 and/or displayed by the display unit 34 can be printed on a medium 114 for elaborating a document that concerns a space, as for example a protocol.

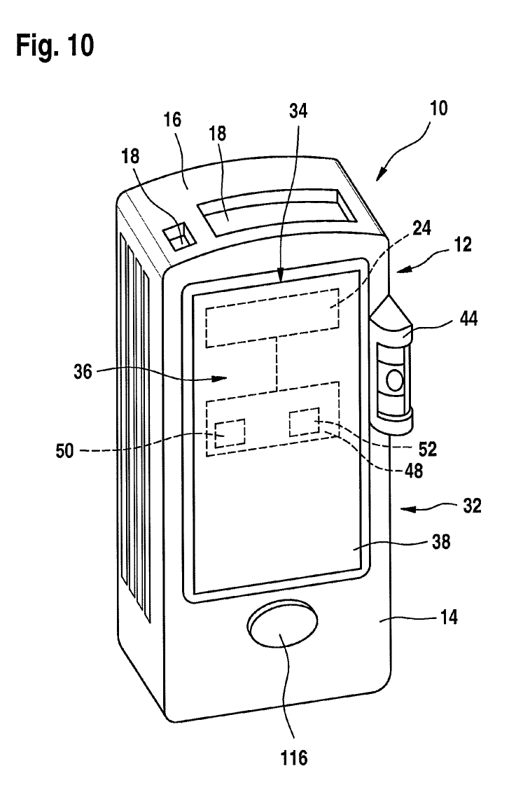

FIG. 10 shows an alternative embodiment of the distance measuring device 10. Thereby the components, which correspond with the previous embodiments, are not given new terms. The operating interface 32 provides in addition to the touch-sensitive input unit 36 an operating element 116 that is arranged as an operating key. This operating element 116 is assigned in particular to a control function of the control unit 48 for controlling a measuring process of the measuring unit 24. If for example the body 12 is kept in a position, which complicates the operating of the input unit 36 by the track point 40 or a finger, advantageously an activation of a measuring process for example, in particular in an operating mode of the control unit 48 that is shown in FIG. 6 or 8, can be simply achieved by operating the operating element 116.

1-12. (canceled)

13. A distance measuring device, comprising:
a control unit having a drawing mode used to create a drawing.

14. The distance measuring of claim 13, further comprising a touch-sensitive input unit that further used to create the drawing.

15. The distance measuring device of claim 13, wherein the control unit is configured to create a drawing by a sketching of an operator.

16. The distance measuring device of claim 15, wherein the control unit is configured to process a distance that has been sketched by an operator at least semi-automatically.

17. The distance measuring device of claim 13, further comprising a memory unit for saving the drawing.

18. The distance measuring device of claim 13, wherein the control unit is configured to create the drawing by a measuring result at least semi-automatically.

19. The distance measuring device of claim 18, wherein the control unit is configured to adapt the drawing to a measuring result.

20. The distance measuring device of claim 13, wherein the control unit further comprises:
a data interface; and
a control unit program for implementing the drawing mode;
wherein the drawing mode is used to create the drawing by data that is read by the data interface.

21. The distance measuring device of claim 13, wherein the control unit includes an operating mode that provides a display field for displaying a distance information that is assignable to a distance that is determined by the drawing by an input of an operator.

22. The distance measuring device of claim 21, wherein the control unit is configured to assign a control function for controlling a measuring of the distance to a shown symbol that is assigned to the distance.

23. The distance measuring device of claim 13, wherein the control unit further comprises a data interface for creating a data connection with a pressure unit, wherein a pressure mode of the control unit transfers pressure data by the drawing to the pressure unit.

24. The distance measuring device of claim 13, wherein the control unit further comprises an operating mode and a data interface configured to download a program for implementing the drawing mode over the data interface from an external data unit.
